(19) United States
(12) Patent Application Publication
(10) Pub. No.: US 2015/0120381 A1
(43) Pub. Date: Apr. 30, 2015

(54) RETAIL SALES OVERLAPPING PROMOTIONS FORECASTING USING AN OPTIMIZED P-NORM

(71) Applicant: Oracle International Corporation, Redwood Shores, CA (US)

(72) Inventors: Catalin POPESCU, Atlanta, GA (US); Lin HE, Johns Creek, GA (US); Ming LEI, Atlanta, GA (US); Chun TANG, Alpharetta, GA (US)

(21) Appl. No.: 14/062,140

(22) Filed: Oct. 24, 2013

(51) Int. Cl. G06Q 30/02

(52) U.S. Cl. CPC G06Q 30/0202
USPC 705/7.31

(57) ABSTRACT

A system that generates a sales forecast for an item receives the sales history for prior sales periods that includes at least one stand-alone time period when a single promotion event is active, and at least one overlapping time period when two or more promotion events are active and overlapping. For each stand-alone time period, the system determines a stand-alone lift for each promotion event active during the stand-alone time periods. For each overlapping time period, the system determines a combined overlap lift of promotion events that are overlapping using a p-norm.

### FIELD

One embodiment is directed generally to a computer system, and in particular to a computer system that forecasts sales of retail items.

### BACKGROUND INFORMATION

Retailers frequently initiate promotions to boost sales and ultimately increase profit. There are many types of promotions that a retailer may initiate, depending on the time frame and the type of retail items. Examples of possible promotions for retail items include temporary price cuts, rebates, advertisements in a newspaper or a website or via email, coupons, special placement of items in a store, etc. For some items, multiple promotions are active at the same time, referred to as “overlapping promotions”. For example, a particular brand and size of soda may be featured in a supermarket flyer, may be given a special up-front shelf space, and may be offered at a temporary 60% discount. All three of these promotions may occur during the same time frame.

Retailers must also formulate sales forecasts. For the purpose of replenishment, planning and allocation, the retailer needs to have an estimate of how much of an item is likely to be sold at a store for a given number of days or weeks. However, retail sales forecasting is a very complex problem to solve as the number of items for a large retailer can easily be in the hundreds of thousands, the number of stores in the thousands, and the number of forecasting time periods in the tens. The resulting number of forecast data points can be in the billions. The problem becomes even more complex when the forecast needs to incorporate the effects of events such as promotions.

### SUMMARY

One embodiment is a system that generates a sales forecast for an item. The system receives the sales history for prior sales periods that includes at least one stand-alone time period when a single promotion event is active, and at least one overlapping time period when two or more promotion events are active and overlapping. For each stand-alone time period, the system determines a stand-alone lift for each promotion event active during the stand-alone time periods. For each overlapping time period, the system determines a combined overlap lift of promotion events that are overlapping using a p-norm.

### BRIEF DESCRIPTION OF THE DRAWINGS

FIG. 1 is a block diagram of a computer server/system in accordance with an embodiment of the present invention.

FIG. 2 is a flow diagram of the functionality of the overlapping promotions module of FIG. 1 when determining the effects of overlapping promotions for retail forecasting in accordance with one embodiment.

FIG. 3 is a flow diagram of the functionality of overlapping promotions module 16 of FIG. 1 when determining an optimized value of p in accordance with one embodiment for each product/location combination.

### DETAILED DESCRIPTION

One embodiment is a system that generates a sales forecast during time periods in which overlapping promotions occur. The system determines an overlapping promotion adjustment factor to adjust the forecast, and the factor is determined using an optimized p-norm.

A “p-norm” or “p” is a special type of “norm” that in general is a mathematical function that assigns a positive length or size to each vector in a vector space, other than the zero vector. A p-norm can be defined as follows:

Let p≧1 be a real number:

$${‖ x ‖}_{p} := {( {\sum }_{i = 1}^{n} {\vert {x}_{i} \vert}^{p} )}^{1 / p} .$$

For p=1, the p-norm becomes a “taxicab” norm, for p=2 the p-norm becomes a “Euclidean” norm, and as p approaches c° the p-norm approaches the “infinity” norm or “maximum” norm.

In general, an “overlapping promotion” is an instance where an item and retail store location combination has multiple promotions active for the same time period. One way the overlapping promotions can be accounted for in retail forecasting (i.e., forecasting a lift over a baseline forecast in response to a promotion) is to estimate the effects of each promotion independently, and use a weight when applying each promotion to a baseline forecast. The weighted promotions are then used as variables in a stepwise linear regression algorithm to determine the retail forecast.

For example, promotion A may have an estimated lift of a 20% increase in demand, while promotion B may have an estimated lift of a 30% increase in demand. If the two promotions are active in the same time period, then the total lift may be: (0.7×0.2)+(0.7×0.3)=35%,

where a weight of 0.7 was applied to the individual lifts to account for the fact that two promotions were overlapping.

Another alternative for accounting for overlapping promotions is using the following formula:

combined lift=square root of the sum of lift_of_promo_{—}A squared and lift_of_promo_{—}B squared

Using the numbers from the above example: combined lift=sqrt(0.2̂2+0.3̂2)=36%

However, there are multiple drawbacks to these methods. For one, the promotional lifts are estimated from data points where the promotions may have occurred by themselves, or may have been overlapping other promotions. This usually distorts the estimate value. Further, determining the weight to be applied when promotions are overlapping (i.e., the 0.7 in the above example) is non-trivial. First, the weight may be different from promotion to promotion. Further, the weight of promotion A in combination with promotion B may have the weight of 0.7, but the weight of promotion A in combination with promotion C, may be 0.6. Further, the weights are updated manually, which means that this is a very time-consuming process. Because of the lengthy process, the values of the weights are not revisited on a timely fashion, which means that they can become stale after a while. Further, the user who manually updates the weights usually uses gut-feeling rather than analytics to come up with values, which may not lead to the most accurate forecasts. In contrast, embodiments use an adjustment factor that is based on an optimized p-norm.

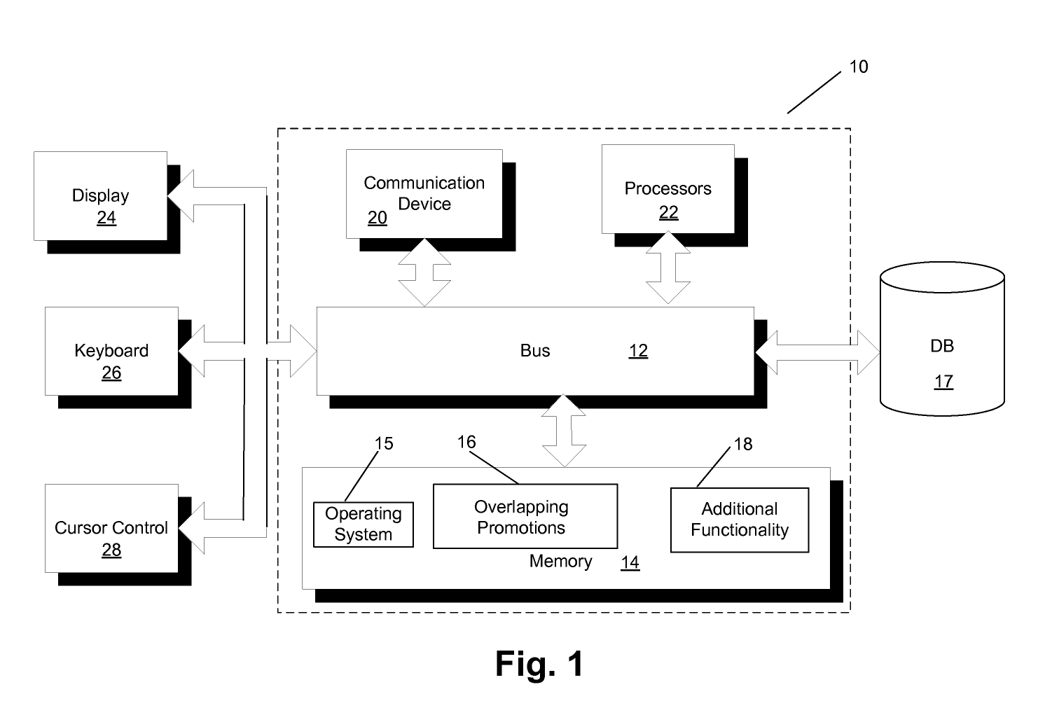

FIG. 1 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, for functionality of a user client, system 10 may be a smartphone that includes a processor, memory and a display, but may not include one or more of the other components shown in FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an overlapping promotions module 16 for determining the effects of overlapping promotions for retail forecasting, and all other functionality disclosed herein. System 10 can be part of a larger system. Therefore, system 10 can include one or more additional functional modules 18 to include the additional functionality, such as “Retail Demand Forecasting” from Oracle Corp. A database 17 is coupled to bus 12 to provide centralized storage for modules 16 and 18.

One embodiment provides a retail sales forecast that accounts for overlapping promotions or any type of overlapping promotion event to boost sales, or increase traffic in stores, or clear merchandise, or all of the above. To be able to forecast such actions, embodiments decouple the promotional sales from the baseline sales. Embodiments then model sales for a period t to equal baseline sales for period t plus the sum of all promotional lifts occurring in that period. Known linear regression techniques can then be used to determine the sales forecast.

As discussed, overlapping promotions occur when during a particular time period more than one promotion event is active, such as when an item is placed in the front of the store and is also advertised in a flyer, or when an item is discounted and is also advertised in an email “blast”. In the latter example, it is very difficult to assess what part of the promotional lift can be attributed to the discount and what part to the email notification. The problem becomes even harder when three or more promotion events are active at the same time. For instance, an item is in the front cap, is discounted, and is advertised in a flyer.

One embodiment, as discussed, determines the promotion lift/effect that accounts for overlapping promotions. A promotion effect type can be additive or multiplicative. Embodiments may include either of two different models that describe demand, or both models. In an “additive” model, the demand can be modeled as the baseline demand plus the promotion effects. In a “multiplicative” model, the demand can be modeled as the baseline demand times the product of promotion effects. In general, if the promotions are either on or off (i.e., Boolean), the additive model is used. Examples of Boolean promotions include: is the advertised item on the front isle (Yes/No), was the item featured in an ad (Yes/No), etc. However, if at least one of the variables is continuous, embodiments automatically switch to the multiplicative model. An example of a continuous variable is price discount, which can be anywhere from 99% to 1%. Another such variable could be the number of customers entering the store in any given period.

When the promotion effect type is additive:

Sales(t)=Baseline(t)+X₁(t)*β₁+X₂(t)*β₁+X₂+ . . . +X_{N}(t)*β_{N};

where:

Sales(t)=sales at time t;

Xᵢ(t)=promotion i at time t;

βᵢ=effect of promotion i.

Embodiments apply an overlapping promotion adjustment factor p (“p-norm”):

$$Sales ( t ) = Baseline ( t ) + f ( t ) * \sqrt[p]{{\vert {X}_{1} ( t ) * {β}_{1} \vert}^{p} + {\vert {X}_{2} ( t ) * {β}_{2} \vert}^{p} + … + {\vert {X}_{N} ( t ) * {β}_{N} \vert}^{p}}$$

where f(t) is to adjust the lift if there is any “negative” promotions:

$$f ( t ) = \frac{( {X}_{1} ( t ) * {β}_{1} + {X}_{2} ( t ) * {β}_{2} + … + {X}_{N} ( t ) * {β}_{N} )}{( \vert {X}_{1} ( t ) * {β}_{1} \vert + \vert {X}_{2} ( t ) * {β}_{2} \vert + … + \vert {X}_{N} ( t ) * {β}_{N} \vert )}$$

A negative promotion is a promotion with a negative effect. While a retailer expects a positive effect on demand when promoting merchandise, there may be cases when the effect is negative. For example, if a grocer promotes regular and organic blueberries for the same low price, it is very likely that the organic blueberries will sell very well, but the regular blueberries will sell less than usual, because everybody will buy organic. For the regular blueberries, the effect of the promotion is negative.

In one embodiment, p=1 in the above formula. In other embodiments, the value of p is optimized, as described in detail below.

When the promotion effect type is multiplicative:

Sales(t)=Baseline(t)*R(t)

where

R(t)=(1+X1(t)*β1)*e^{X2(t)*)β2}

Embodiments apply similar p-adjustment on the logarithm on R(t):

$$log ( R ( t ) ) = f ( t ) * \sqrt[p]{{\vert log ( ( 1 + {X}_{1} ( t ) * {β}_{1} ) ) \vert}^{p} + {\vert {X}_{2} ( t ) * {β}_{2} \vert}^{p}}$$

and

$$f ( t ) = \frac{( log ( 1 + {X}_{1} ( t ) * {β}_{1} ) + {X}_{2} ( t ) * {β}_{2} ( t ) )}{( \vert log ( 1 + {X}_{1} ( t ) * {β}_{1} ) \vert + \vert {X}_{2} ( t ) * {β}_{2} ( t ) \vert )}$$

In order to account for overlapping promotions, embodiments examine historical demand from where promotions were active. As an example, the following may be the historical demand over 15 past time periods where two types of promotion events are active, “discount” and “email”:

| | Period | | | | | | | | | | | | | | |
|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 |
| discount | | | X | | | X | | | | X | | | X | | |
| email | | | X | | | | X | | | X | | | | X | |

As shown, the item was discounted in periods 3, 6, 10, and 13. The item was advertised in an email in periods 3, 7, 10 and 14.

Embodiments then run linear stepwise regression to solve the equation modeling the process for the additive model: Sales=baseline+sum of promotional lifts. The two promotion events are treated as independent and the effect/lift is determined for each. This assumes that an event has the same effect on the demand if active by itself or in conjunction with another event. However, when promotion events are overlapping, their individual contribution is less than if they occur by themselves. Embodiments correct for this when determining the sales forecast, as described below.

In one embodiment, the “causal”, or “promotional” forecasting used by Retail Demand Forecasting Release 13.4.1, from Oracle Corp., using the promotion events disclosed above is implemented. For example, embodiments receive three input streams: (1) Time Series Data; (2) Historical Promotional Calendar; and (3) Future Promotional Calendar. The problem of promotional forecasting is then decomposed into two subtasks: (1) Estimating the effect that promotions have on demand; and (2) Forecasting baseline (i.e., no promotions) demand. To accomplish the first task, a stepwise regression routine is used in one embodiment. This routine takes a time series and a collection of promotional variables and determines which variables are most relevant and what effect those relevant variables have on the series. Thus, the output from the algorithm is a selection of promotional variables and the effects of those variables on the series

In one embodiment, in matrix form the regression equation can be modeled as:

Y=X*B+noise;

where X and Y are the independent and dependent variables, respectively, with the dimensionalities being:

Y: n-by-1;

X: n-by-m;

B: m-by-1;

where “Y” represents the historical sales, and “X” represents the promotions, with “n” being the number of time periods for which sales and promotions are recorded. Vector B has “m” components, with the intercept representing the baseline, while the other “m−1” components represent the effects of the available promotions.

Embodiments then solve the linear regression model to generate the effects. As described, the equation to be solved is Y=X*B+noise, and the solution to the equation is: B=(X¹*X)⁻¹*X¹*Y.

In the above example, solving the regression yields the following promotion effects:
The discount promotion event accounts for 100 units of lift; and
The email promotion event accounts for 50 units of lift.

Embodiments then forecast the baseline, which was not influenced by the above effects, using known methods. After the baseline is forecast, the promotion effects are applied. Continuing the previous example, consider the following promotion plan for future time periods 101-115 to be used for a sales forecast:

| | period | | | | | | | | | | | | | | |
|---|---|---|---|---|---|---|---|---|---|---|---|---|---|---|---|
| | 101 | 102 | 103 | 104 | 105 | 106 | 107 | 108 | 109 | 110 | 111 | 112 | 113 | 114 | 115 |
| discount | | | X | | | X | | | | X | | | X | | |
| email | | | X | | | | X | | | X | | | | X | |

As shown, there will be a discount event in place for periods 103, 106, 110, and 113. There will be an email event in periods 103, 107, 110 and 114. For periods 103 and 110, the two events are active simultaneously. Adding their effects, for those periods, would overstate the demand, so embodiments correct for the overstatement. Specifically, embodiments combine the lifts for the overlapping periods (i.e., periods 103 and 110 in the above example) as follows:

$$total lift = \sqrt[p]{{( discount lift )}^{p} + {( email lift )}^{p}} .$$

Continuing with the above example, for p=1.5, the total lift would be determined as:

$$total lift = \sqrt[1.5]{{100}^{1.5} + {50}^{1.5}} = 122 units ;$$

which is used instead of the straight summation of the effects (i.e., 100+50=150).

As discussed above, instead of using a predetermined value of the parameter p, or letting a user select a value (e.g., 1.5 in the example above), embodiments determine an optimized value of p. In one embodiment, to determine the optimized value using the above example, embodiments find instances in the sales history where the email and discount events were active at the same time, and records the sales and historical baseline values. Embodiments then determine an error term as sales less baseline, less total lift of the combined event lifts as a function of p. p is the only unknown in this equation. Embodiments perform this for a range of values for p, and select the value that yields the smallest error.

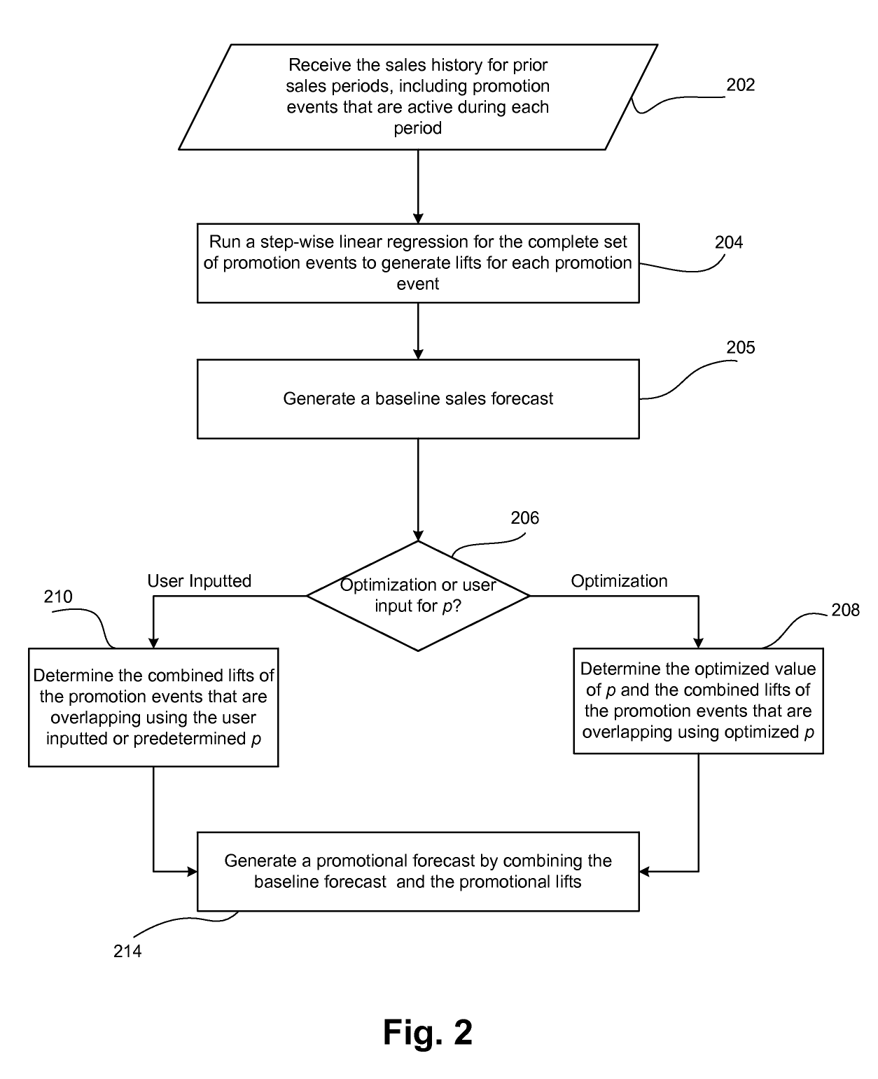

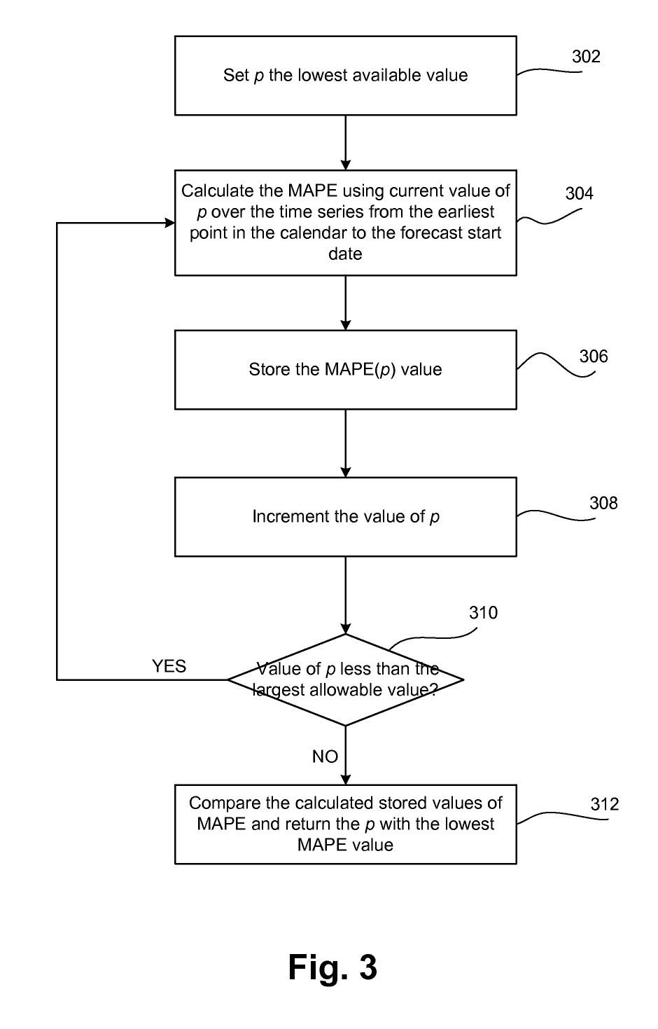

FIG. 2 is a flow diagram of the functionality of overlapping promotions module 16 of FIG. 1 when determining the effects of overlapping promotions for retail forecasting in accordance with one embodiment. In one embodiment, the functionality of the flow diagram of FIG. 2, and FIG. 3 below, is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 202, the sales history for prior sales periods is received. The sales history includes promotion events that are active during each period (i.e., a complete set of promotion events). Time periods in which an individual promotion event is active and time periods in which overlapping promotion events are active are noted.

At 204, a step-wise linear regression is run for the complete set of promotion events. As a result, the promotional lifts or promotional effect values are determined for each individual promotion event.

At 205, a baseline sales forecast is generated using known methods.

At 206, it is determined if the value of the p-norm/p is going to be provided via user input or otherwise predetermined, or optimized using the optimizing functionality disclosed above and in conjunction with FIG. 3 below.

If optimization at 206, at 208 the optimization functionality is executed and the combined lifts of the promotion events that are overlapping are determined using the optimized value of p.

If user input at 206, at 210 the combined lifts of the promotion events that are overlapping are determined using the user provided or predetermined value of p.

At 214, a promotional forecast is generated by combining the baseline forecast from 205 and the promotional lifts from 208 and 210, or the lifts from 204 for periods where no overlapping promotions are active. For periods with overlapping promotions, the lifts from 204 are combined using the p-norm. The generated promotional forecast provides a forecast of future sales that takes into account overlapping promotions. If the demand model is multiplicative, as described above, the promotional forecast is generated by multiplying the baseline demand by the product of the promotion effects.

In one embodiment, when the p-norm is to be optimized, an optimization routine is run to find the value of p that minimizes the Mean Absolute Percentage Error (“MAPE”). FIG. 3 is a flow diagram of the functionality of overlapping promotions module 16 of FIG. 1 when determining an optimized value of p in accordance with one embodiment for each product/location combination.

At 302, p is set to the lowest available value. The lower limit for p is an adjustable parameter. However, a good candidate is a number greater than 0, e.g., 0.5.

At 304, module 16 calculates MAPE using the current value of p by iterating over the time series from the earliest point in the calendar to the forecast start date. As an example, if trying to find the overlapping effect of promotions X₁ and X₂, with effects β1 and β2, respectively, the algorithm is as follows:

$$MAPE ( p ) = \frac{1}{N} {\sum }_{i = 1}^{N} \frac{\vert HB ( i ) * {( {β}_{1}^{p} + {β}_{2}^{p} )}^{1 / p} - Sales ( i ) \vert}{Sales ( i )}$$

For the additive case or

$$MAPE ( p ) = \frac{1}{N} {\sum }_{i = 1}^{N} \frac{\vert HB ( i ) * exp \{ {[ {( ln {β}_{1} )}^{p} + {( ln {β}_{2} )}^{p} ]}^{1 / p} \} - Sales ( i ) \vert}{Sales ( i )}$$

For the multiplicative case

Where:
HB: historical baseline sales;
Sales: historical sales (including promotions);
N: number of periods in history where promotions X₁ and X₂ were overlapping;
Bᵢ: effect of promo Xᵢ;
i: is period where promotions X₁ and X₂ were overlapping.

At 306, the MAPE(p) value is stored.

At 308, the value of p is incremented. The value of the increment determines how refined the search is for the optimal value. The increment is a parameter that can be adjusted. However, a good candidate is 0.01.

At 310, it is determined if the value of p is less than the largest allowable value. The upper limit for p is a parameter that can be adjusted. However, a good candidate is a number considered large in the context of a p-norm (e.g., 5).

If yes at 310, the functionality continues at 304 where the MAPE is calculated using the new incremented value of p.

If no at 310, at 312 the calculated stored values of MAPE are compared, and the p with the lowest MAPE value is returned. This p is the optimized value for the given product/location combination.

The functionality of FIG. 3 is repeated as needed for each different time series to generate an optimized p value for each product/location combination. Therefore, the p value is optimized for the sales forecast for any item.

As disclosed, embodiments generate a sales forecast for a product/location combination with overlapping promotion events. The value of p is optimized to function as an adjustment factor to account for the effects of the overlapping events.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer-readable medium having instructions stored thereon that, when executed by a processor, cause the processor to generate a sales forecast for an item, the generating the sales forecast comprising:
receiving sales history for prior sales periods comprising at least one stand-alone time period when a single promotion event is active, and at least one overlapping time period when two or more promotion events are active and overlapping;
for each stand-alone time period, determining a stand-alone lift for each promotion event active during the stand-alone time periods; and
for each overlapping time period, determining a combined overlap lift of the promotion events that are overlapping using a p-norm.

2. The computer-readable medium of claim 1, the generating the sales forecast further comprising:
generating a baseline sales forecast;
generating a promotional sales forecast comprising combining the baseline sales forecast, the stand-alone lifts and the overlap lifts.

3. The computer-readable medium of claim 1, the generating the sales forecast further comprising:
generating a baseline sales forecast;
generating a promotional sales forecast comprising multiplying the baseline sales forecast, the stand-alone lifts and the overlap lifts.

4. The computer-readable medium of claim 1, wherein the determining the combined overlap lift comprises receiving a value of the p-norm.

5. The computer-readable medium of claim 1, wherein the determining the combined overlap lift comprises optimizing a value of the p-norm.

6. The computer-readable medium of claim 5, wherein the optimizing comprises finding the value of the p-norm that minimizes the Mean Absolute Percentage Error.

7. The computer-readable medium of claim 6, wherein the optimizing comprises for overlapping promotions X₁ with effect β1 and X₂ with effect β2:
$$MAPE ( p ) = \frac{1}{N} {\sum }_{i = 1}^{N} \frac{\vert HB ( i ) * {( {β}_{1}^{p} + {β}_{2}^{p} )}^{1 / p} - Sales ( i ) \vert}{Sales ( i )}$$
wherein HB comprises historical baseline sales, sales comprises historical sales including promotions, N comprises a number of periods in history where promotions X₁ and X₂ were overlapping, Bᵢ comprises an effect of promo Xᵢ, and i comprises a period where promotions X₁ and X₂ were overlapping.

8. The computer-readable medium of claim 6, wherein the optimizing comprises for overlapping promotions X₁ with effect β1 and X₂ with effect β2:
$$MAPE ( p ) = \frac{1}{N} {\sum }_{i = 1}^{N} \frac{\vert HB ( i ) * exp \{ {[ {( ln {β}_{1} )}^{p} + {( ln {β}_{2} )}^{p} ]}^{\frac{1}{p}} \} - Sales ( i ) \vert}{Sales ( i )}$$
wherein HB comprises historical baseline sales, sales comprises historical sales including promotions, N comprises a number of periods in history where promotions X₁ and X₂ were overlapping, Bᵢ comprises an effect of promo Xᵢ, and i comprises a period where promotions X₁ and X₂ were overlapping.

9. A method of generating a sales forecast for an item, the method comprising:
receiving sales history for prior sales periods comprising at least one stand-alone time period when a single promotion event is active, and at least one overlapping time period when two or more promotion events are active and overlapping;
for each stand-alone time period, determining a stand-alone lift for each promotion event active during the stand-alone time periods; and
for each overlapping time period, determining a combined overlap lift of the promotion events that are overlapping using a p-norm.

10. The method of claim 9, further comprising:
generating a baseline sales forecast;
generating a promotional sales forecast comprising combining the baseline sales forecast, the stand-alone lifts and the overlap lifts.

11. The method of claim 9, further comprising:
generating a baseline sales forecast;
generating a promotional sales forecast comprising multiplying the baseline sales forecast, the stand-alone lifts and the overlap lifts.

12. The method of claim 9, wherein the determining the combined overlap lift comprises receiving a value of the p-norm.

13. The method of claim 9, wherein the determining the combined overlap lift comprises optimizing a value of the p-norm.

14. The method of claim 13, wherein the optimizing comprises finding the value of the p-norm that minimizes the Mean Absolute Percentage Error.

15. The method of claim 14, wherein the optimizing comprises for overlapping promotions X₁ with effect β1 and X₂ with effect β2:
$$MAPE ( p ) = \frac{1}{N} {\sum }_{i = 1}^{N} \frac{\vert HB ( i ) * {( {β}_{1}^{p} + {β}_{2}^{p} )}^{1 / p} - Sales ( i ) \vert}{Sales ( i )}$$
wherein HB comprises historical baseline sales, sales comprises historical sales including promotions, N comprises a number of periods in history where promotions X₁ and X₂ were overlapping, Bᵢ comprises an effect of promo Xᵢ, and i comprises a period where promotions X₁ and X₂ were overlapping.

16. The method of claim 14, wherein the optimizing comprises for overlapping promotions X₁ with effect β1 and X₂ with effect β2:
$$MAPE ( p ) = \frac{1}{N} {\sum }_{i = 1}^{N} \frac{\vert HB ( i ) * exp \{ {[ {( ln {β}_{1} )}^{p} + {( ln {β}_{2} )}^{p} ]}^{1 / p} \} - Sales ( i ) \vert}{Sales ( i )}$$
wherein HB comprises historical baseline sales, sales comprises historical sales including promotions, N comprises a number of periods in history where promotions X₁ and X₂ were overlapping, Bᵢ comprises an effect of promo Xᵢ, and i comprises a period where promotions X₁ and X₂ were overlapping.

17. A sales forecasting system comprising:
an overlap determination module that receives sales history for prior sales periods comprising at least one stand-alone time period when a single promotion event is active, and at least one overlapping time period when two or more promotion events are active and overlapping; and
a promotion lift generator that for each stand-alone time period, determines a stand-alone lift for each promotion event active during the stand-alone time periods, and for each overlapping time period, determines a combined overlap lift of the promotion events that are overlapping using a p-norm.

18. The sales forecasting system of claim 17, further comprising:
a forecast module that generates a baseline sales forecast and generates a promotional sales forecast comprising combining the baseline sales forecast, the stand-alone lifts and the overlap lifts.

19. The sales forecasting system of claim 17, further comprising:
a forecast module that generates a baseline sales forecast and generates a promotional sales forecast comprising multiplying the baseline sales forecast, the stand-alone lifts and the overlap lifts.

20. The sales forecasting system of claim 17, wherein the determine the combined overlap lift comprises optimizing a value of the p-norm.
